(19) United States
(12) Patent Application Publication
(10) Pub. No.: US 2006/0117263 A1
(43) Pub. Date: Jun. 1, 2006

(54) Method and system for inhibiting overlooking notifications in applications

(76) Inventor: David Locke, Chandlers Ford (GB)

Correspondence Address: IBM CORPORATION, 3039 CORNWALLIS RD., DEPT. T81 / B503, PO BOX 12195, REASEARCH TRIANGLE PARK, NC, 27709, US

(21) Appl. No.: 11/205,404

(22) Filed: Aug. 17, 2005

(30) Foreign Application Priority Data
Nov. 26, 2004 (GB) 0425997.4

(51) Int. Cl. G06F 17/00

(52) U.S. Cl. 715/751

(57) ABSTRACT

The erroneous overlooking of notifications in applications is inhibited. In response to a request for closure of an application interface, for example, an instant messaging session window, two checks can be used. In the first, a check is made to see if the application interface has been selected since the last notification and, if the application interface has not been selected, a confirmation of the closure is sought. In the second, a check is made to see if the time period since the last notification was received is less than a predefined threshold time period and, if the time period is less than the threshold, confirmation of the closure is sought.

### TECHNICAL FIELD

This invention relates to the field of inhibiting overlooking notifications in applications. In particular, the invention relates to inhibiting overlooking unread messages in instant messaging applications.

### BACKGROUND OF THE INVENTION

The present invention is described in the context of instant messaging in order to provide a detailed description of embodiments of implementations of the invention and how these address the shortcomings of the prior art. However, the present invention could equally be applied to other applications and should not be construed as being limited to instant messaging applications. The present invention may be applied to any applications which involve non-user generated events, notifications or alerts received at the application of which the user should be aware.

Instant messaging (IM) enables a user to send and receive messages to and from other users in real time. A first user has an Im client software application that runs on his computer. When the first user is online, by being connected to a network such as the Internet, the IM client application opens a connection to an IM server. The IM client application sends a user identification and password to log onto the IM server. The IM server uses a communication protocol that allows for Im functionality.

The IM client application includes a contact list, which is a list of other users that the first user wishes to have the ability to send messages to. When the users identified in the contact list come online and log on to the IM server, the first user is notified so that messages can be sent and received. A message is sent to the IM server, which then routes the message to the identified user. In some implementations of IM systems, messages are sent directly between the IM client applications and the IM server is not involved in the transfer of messages.

IM applications are used primarily for text based chats, screen sharing, white-boarding and so on. In the case of a text based chat, the IM client application has a graphical user interface which provides a window on the user's computer display for each chat or session that the user is having with his contacts. The window displays a scrolling dialogue of the chat between the first user and his contact. Participating in an IM session is something busy people often do in parallel with performing other tasks. Such other tasks may include conducting additional IM sessions with other people, reading/authoring documents, programming, or any other activity. When another activity is being performed using a user's computer display, an IM window is out of focus. Other application windows or other IM session windows may overlap or hide the original IM session window.

A user changes focus on graphical windows of different applications usually by selecting a window using a pointing device such as a mouse or by opening a new application which automatically brings the window for the new application to the fore on the user's graphical display. Existing windows are out of focus and may be partly or wholly hidden from the user. Open windows which are hidden usually have a small icon or representation of the open window provided at the edge of the graphical display, for example, in a toolbar. The user is then aware of the windows that are open but which may be hidden behind other windows.

Windows for applications which are not in focus may also be minimized which means that the window is removed from the graphical display but is not closed. Again, a small icon or representation of the minimized window is provided at the edge of the graphical display.

It is very easy for IM windows that contain unread messages to be closed. This may occur, for example, when the IM window close button is hit just as a new message is displayed. This may also occur when closing an IM client application which owns one or more IM session windows. This may also occur when closing down all windows as a result of the operating system or host being closed when there are IM windows hidden or minimised.

Messages received by an IM client application may not be persistent in that they are not saved to disk and are not recovered at the restart of an application. For non-persistent messages it is very important that a user reads all received messages before closing the application. However, it may also be important with persistent messages that are saved to disk as the message may be urgent.

An aim of the invention is to provide a technique for minimising the loss of notifications such as messages that have been received by an application but have not been read by the end user.

### SUMMARY OF THE INVENTION

According to a first aspect of the present invention there is provided a method for inhibiting overlooking of notifications in an application comprising: requesting closure of an application interface; determining whether it is possible for a notification to have been overlooked; in response to determining that this is possible, seeking confirmation of the closure.

In one embodiment, it is determined whether it is possible for a notification to have been overlooked by checking if the application interface has been selected since the last notification; and, if the application interface has not been selected, seeking confirmation of the closure.

In the step of checking, if the application interface has been selected, the method may include carrying out the step of: checking if the application interface was selected for a time period less than a predefined threshold time period; and, if so, seeking confirmation of the closure.

After the step of requesting closure of an application interface, the method may also include: checking if the time period since the last notification was received is less than a predefined threshold time period; and, if the time period is less than the threshold, seeking confirmation of the closure.

According to one embodiment, the invention comprises: requesting closure of an application interface; checking if the time period since the last notification was received is less than a predefined threshold time period; and if the time period is less than the threshold, seeking confirmation of the closure.

If an action has been carried out on the application after the last notification was received, the method may include skipping the step of seeking confirmation of the closure.

After the step of requesting closure of an application interface, the method may also include: checking if the application interface has been selected since the last notification; and if the application interface has not been selected, seeking confirmation of the closure.

According to a third aspect of the present invention there is provided a system for inhibiting overlooking notifications in an application comprising: an application including means for receiving notifications; an application interface for the application; means for requesting closure of the application interface; means for determining whether it is possible for a notification to have been overlooked; means, responsive to determining that this is possible, for seeking confirmation of the closure.

According to one embodiment, the system preferably provides means for checking, in response to a closure request, if the application interface has been selected since the last notification was received; and means for seeking confirmation of the closure, if the application interface has not been selected,

The system may include: means for checking if the application interface was selected for a time period less than a predefined threshold time period. If the application interface was selected for a time period less than the predefined threshold time period, then the system preferably requests confirmation of closure.

The system may also include: means for checking if the time period since the last notification was received is less than a predefined threshold time period. If this is true, then confirmation of closure is preferably sought.

According to one embodiment, the system comprises: means for checking, in response to a closure request, if the time period since the last notification was received is less than a predefined threshold time period; and means for seeking confirmation of the closure, if the time period is less than the threshold.

The system may also include: means for checking if the application interface has been selected since the last notification. If this is not the case, then the system is preferably able to seek confirmation of closure.

According to one embodiment, if it is determined that an action has been carried out on the application after the last notification was received, then confirmation of closure is not sought.

According to a fifth aspect of the present invention there is provided a computer program product for inhibiting overlooking of notifications in an application, the computer program product stored on a computer readable storage medium, comprising computer readable program means for performing the steps of: requesting closure of an application interface; determining whether it is possible for a notification to have been overlooked; in response to determining that this is possible, seeking confirmation of the closure.

In order to determine whether it is possible for a notification to have been overlooked, the computer program product is preferably further adapted to perform the steps of: checking if the time period since the last notification was received is less than a predefined threshold time period; and if the time period is less than the threshold, seeking confirmation of the closure. In another embodiment, it is checked whether the application interface has been selected since the last notification, and if not then confirmation of closure is sought.

In all the above aspects of the present invention, the application interface may be an application graphical window and selecting the application interface may focus on the application graphical window.

Preferably, the application is an instant messaging client application, the application interface is an instant messaging session window, and the notification is a received message in an instant messaging session.

The present invention is preferably implemented in computer software.

Embodiments of the present invention will now be described, by way of examples only, with reference to the accompanying drawings.

### BRIEF DESCRIPTION OF THE DRAWINGS

FIG. 1 is a block diagram of an instant messaging system to which the present invention may be applied;

FIG. 2 is a schematic diagram of a graphical display showing an application interface windows to which the present invention may be applied;

FIG. 3 is a schematic diagram of an instant messaging client application in accordance with the present invention;

FIG. 4 is a flow diagram of a first embodiment of a method for inhibiting overlooking of notifications in accordance with an aspect of the present invention; and

FIG. 5 is a flow diagram of a second embodiment of a method for inhibiting overlooking of notifications in accordance with an aspect present invention.

### DETAILED DESCRIPTION

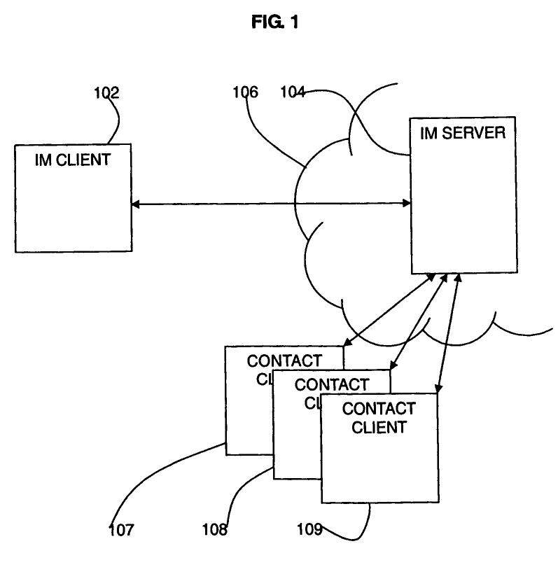

FIG. 1 shows an instant messaging system to which the method and system of inhibiting overlooking of notifications may be applied. An instant messaging (IM) client application 102 runs on a computer of a first user. An Im service application, also referred to as an IM server 104, provides the Im functionality via a network such as the Internet 106.

When the IM client application 102 logs on to the IM server 104, the server 104 checks a screen name and password. This may be done by a separate login server. The IM server 104 uses a communications protocol that allows for IM functionality. The IM client application 102 has a graphical user interface, which displays the instant messaging functionality to the first user on a graphical display of the first user.

The IM client application 102 includes contact list capabilities. A list of people the first user would like to send and receive messages to and from is stored in the IM client application 102. This list of the screen names of the contacts is communicated to the IM server 104 so that when the listed people come online, the first user is notified by the IM server 104.

Each contact has its own IM client application 107, 108, 109 which runs on each of their computers. When any of the contacts logs on, the first user's Im client application 102 is notified that they are online. Instant messages can then be sent and received in real time. Each message goes to the IM server 104, which routes the message to the intended recipient.

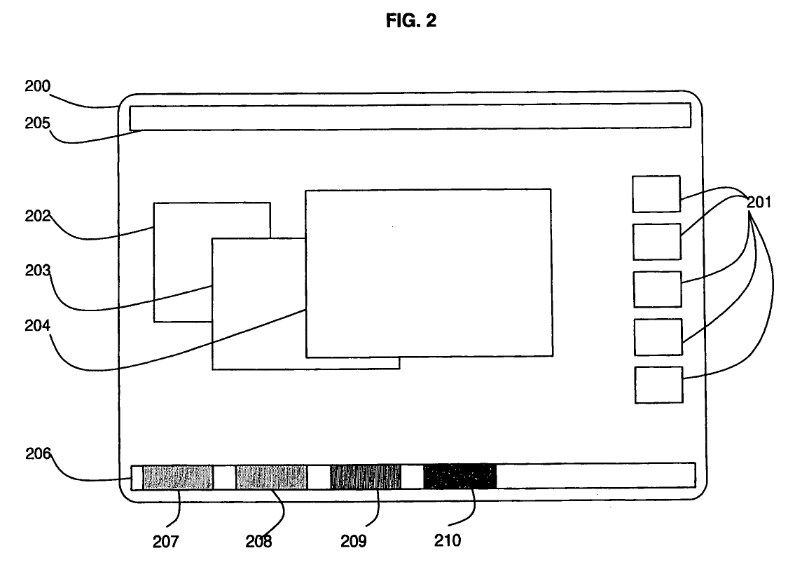

Referring to FIG. 2, a graphical display 200 of a user is shown which may be provided, for example, on a computer screen. The graphical display 200, sometimes referred to as a desktop, usually has a number of icons 201 representing applications available to the user to be run from the graphical display 200. An example of a graphical display 200 is a Windows (trade mark of Microsoft Corporation) display system.

Applications which are currently operating on the graphical display 200 each have one or more graphical windows 202, 203, 204. If more than one window is displayed, the windows may overlap with a current, in focus window 204 in the foreground. Windows 202, 203 which are not currently in focus may be partly or wholly hidden behind other windows. Windows which are open but not in focus may also be minimized to make them smaller or to reduce them to an icon or representation. Any windows that are open but are not in focus, including minimized windows, are referred to as being out of focus.

An application toolbar 205 is provided, often at the top of the graphical display 200, which provides a selection of options for operation of the current, in focus application.

A general toolbar 206 is also provided which may include small graphical indications 207-210 of the applications and windows which are open. One of the indications 210 may represent an application which currently in use and whose window 204 is in focus. Other indications 207, 208 may represent applications which are not currently in use, but whose windows 202, 203 are still displayed but out of focus. Other indications 209 may represent applications which are open but not currently in use and whose windows have been minimized and are therefore not shown on the graphical display 200. These different statuses of the applications represented by the small graphical indications 207-210 in the general toolbar 206, may be shown by highlighting the indications 207-210 in different ways.

The graphical user interface of an IM client application 102 displays one or more IM windows 202, 203, 204 each of which shows a chat between the first user and a contact. When the first user is entering text into a window to send or reading received text, the window is in focus 204. However, when the first user is not using the window, for example, when he is waiting for a reply from his contact, the window is often out of focus 202, 203 by being minimized or covered by a window 204 of another IM session or another application which is in focus and in use by the first user.

When an IM window 202, 203 is out of focus, a small graphical indication 207-209 of the IM window is provided usually in a tool bar 206 of the first user's graphical display 200. The tool bar 206 is generally in view of the first user regardless of the windows open on the display. Typically in known IM client applications, the small graphical indication 207-209 is highlighted in some way when a new message is received enabling the first user to focus on the IM window 202, 203 to read the new message. The highlighting may be by a change in colour, an icon, a sound or other effect.

It is important to ensure that IM windows are not closed when they contain unread messages. This can occur if an IM window is closed from being out of focus. This is particularly likely to occur when all windows on a graphical display are closed simultaneously when an operating system or host is shut down. Messages can also be overlooked if the close command for a window is operated just as a new message is received.

An IM client application is described with functionality to address the problem of overlooking unread messages when closing application windows.

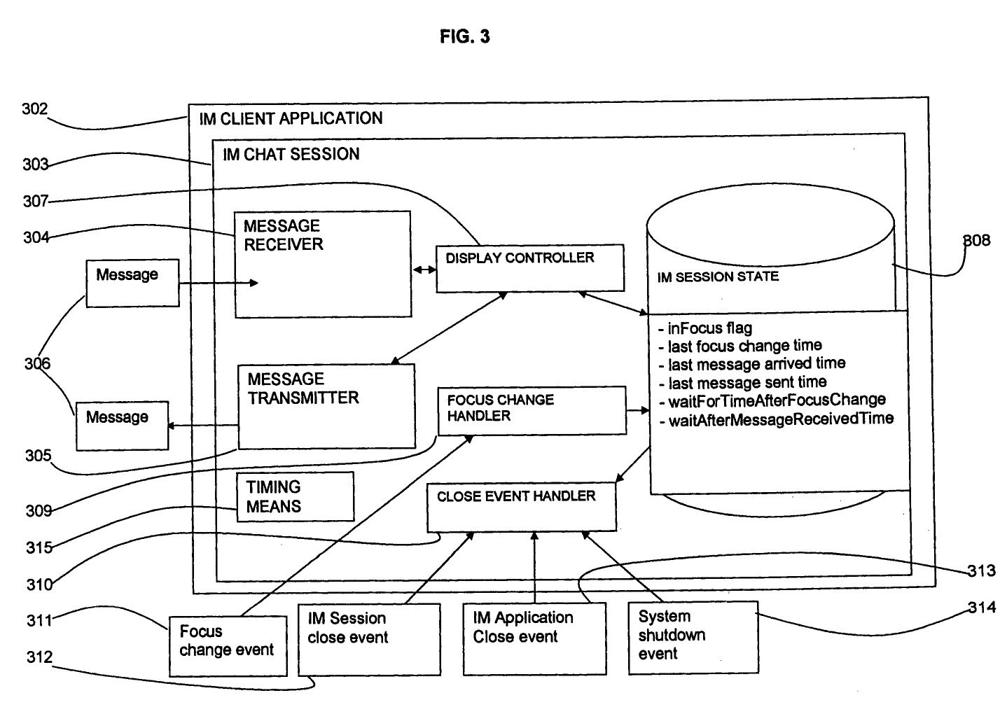

FIG. 3 shows an IM client application 302 with an IM session 303 which provides the functions for an individual chat session. An IM client application 302 may have multiple IM sessions 303 running in parallel. The IM session 303 has a message receiver 304 and a message transmitter 305 for input and output of messages 306 relating to the chat session.

A display controller 307 controls the display of the IM session 303 on a graphical user interface (GUI). GUI widgets are not shown in FIG. 3. A focus change handler 309 receives focus change events 311 from the GUI and changes the state of the session display between focus and out of focus states. A close event handler 310 receives close events such as an IM session close event 312, an IM application close event 313 or a system shutdown event 314 all of which result in the IM session 303 closing.

The IM session 303 has a session state store 308 which includes a store of information relating to the IM session state which may include:

a focus indication such as an in Focus flag;
a last focus change time, a last message arrived time;

a last message sent time, a wait period after focus change referred to as waitForTimeAfterFocusChange (used in the first embodiment described below); and

a wait period after a message received referred to as a waitAfterMessageReceivedTime (used in the second embodiment described below).

A timing means 315 is provided for recording the times for the session state parameters.

Two techniques are described for detecting IM windows that have unread messages when a Im window close request is received. Once detected, the window can be prevented from closing until the user has confirmed it is acceptable to do so.

A first embodiment of a method for inhibiting the overlooking of unread messages requires the Im client application to remember if the IM window has been selected by the user after a new message has arrived. If the IM window has not been selected after a new message has arrived, or has only been selected for a short predefined period of time, and a window closure request is received, confirmation of the window closure request is demanded.

Determining when a window has been used/selected by a user can be done using, standard graphical windowing techniques, for example, when the user selects the window with the mouse, or more generically, when the window been given focus. Both the last time the window had focus and whether a message has arrived since the window gained focus are remembered.

Referring to FIG. 3, a description of the first embodiment is provided.

When the IM session starts:

1) The handle focus event routine of the focus change handler 309 registers interest in GUI focus change events for the IM session GUI window.

2) The handle close event routine of the close event handler 310 registers interest in various close events. This includes:

IM session close event 312. (This may be by closing the session window or activating a close button.)

IM application close event 313. (This closes all IM sessions.)

System shutdown events 314.

3) The in focus flag in the IM session state store 308 is set to true.

4) The last focus change time in the IM session state store 308 is set to the current time.

5) The last message arrived time in the IM session state store 308 is set to 0.

6) The last message sent time in the IM session state store 308 is set to 0.

7) The display controller 307 registers interest in send message button clicks and enter key presses.

8) The waitForTimeAfterFocusChange field in the IM session state store 308 is set to a value, for example, of 1000 milliseconds.

When a new message 306 arrives it is handled by the message receiver 304. The display controller 307 is invoked to display the message 306 in the messages text area widget. The last message arrived time in the IM session state store 308 is updated to reflect the time the message 306 was received.

When the display controller 307 receives a send message button click or enter key press event, it reads the message from the sent message text widget and hands it to the message transmitter 305 to send. The message transmitter 305 sends the message 306 to the IM server. The last message sent time is updated in the IM session state store 308 to the current time. The display controller 307 displays the message sent in the text area widget. The send message text widget is cleared.

When the handle focus event routine 309 is notified of a focus change event 311, the in focus flag is set to indicate if the IM session window is currently in focus or not. The in focus change time is set to the current time.

When the close event routine 310 is notified of a “close” request, the following algorithm is used to determine if a close confirmation dialog should be displayed or not:

Determine if a message has arrived and the Im session window has not had focus since it arrived —

If
a) the in Focus flag is false, and
b) the last message received time comes after the last focus change time
then display the close confirmation prompt.

Determine if a message was received before the IM session window gained focus and that the window has only had focus for a short period of time—

If
a) the in Focus flag is true, and
b) the message received time is before focus change time, and
c) the current time is before last focus change time plus waitForTimeAfterFocusChange,
then display the close confirmation prompt.

If the two previous conditions do not hold, then the Im session can be closed without showing the close confirmation prompt.

If there are multiple IM sessions the logic works in the same way. Alternatively, for a system shutdown request and an Im application shutdown request, the logic can be modified to only display one close confirmation dialogue no matter how many sessions may have unread messages.

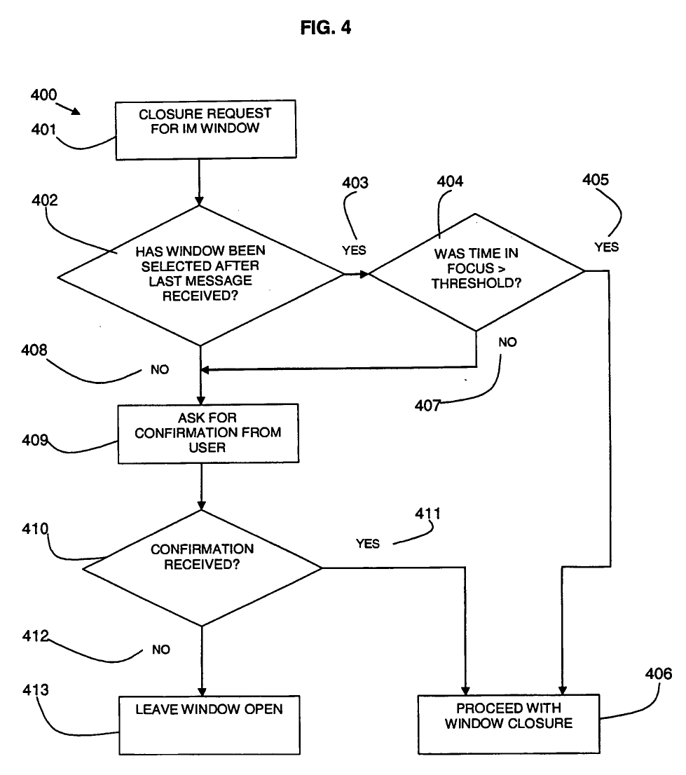

Referring to FIG. 4, a flow diagram 400 of the method of the first embodiment is shown. A closure request 401 is received for an Im window.

It is determined 402 if the window has been selected after the last message arrived. If so 403, it is determined 404 if the window has been in focus for a period of time greater than a predefined threshold short period of time. This step ensures that if a window is focused on momentarily without sufficient time for the user to read a message (for example, when flicking past a window incidentally), this does not count as the window having been in focus. If it is determined 404 that the time in focus is greater than the predefined threshold 405, the closure request is allowed to proceed 406.

If it is determined 404 that the time in focus is not greater than the predefined threshold 407, or it is determined 402 that the window has not been selected after the last message arrived 408, confirmation 409 is requested from the user that the window should be closed. Such a confirmation request may be provided in the form of a dialogue box appearing on the screen with an associated sound which requires an answer before any further action may be taken.

It is determined 410, if confirmation has been received. If so 411, the window closure request may proceed 406. If not 412, the window will remain open 413.

A second embodiment of a method for inhibiting the overlooking of unread messages requires the IM client application to remember the time the last message arrived. If a request to close the IM window is made shortly after a new message arrives, the shutdown of the window(s) can be halted until the user has confirmed it is safe to do so. If a message has been sent since the last message arrived then this rule is not used as it is deemed the user must have read any messages before responding.

If a close request is made for an IM window that has received a message during the last n milliseconds and has not sent a message since the last message arrived, confirmation of the window closure request will be sought with the shutdown of the window halted until the user has confirmed it is safe to do so.

Referring to FIG. 3, a description of the second embodiment is provided.

When the IM session 303 starts, the same steps of 1) to 7) of the first embodiment described above are carried out. Step 8) is replaced with the following step:

8) The waitAfterMessageReceivedTime field in the IM session state store 308 is set to a value of, for example, 5000 milliseconds.

The procedures when a new message 306 arrives, when the display controller 307 receives a send message, and when the handle focus event routine 309 is notified of a focus change, are all the same as for the first embodiment described above.

In the second embodiment, when the close event routine 310 is notified of a “close” request 312, 313, 314, the following algorithm is used to determine if a close confirmation dialog should be displayed or not:

If
a) the last message received time is after the last message send time, and
b) the message received time is after current time minus waitAfterMessageReceivedTime
then display the close confirmation prompt.

If the previous condition does not hold then the IM session can be closed without showing the close confirmation prompt.

As in the first embodiment, if there are multiple Im sessions the logic works in the same way. Alternatively, for a system shutdown request and an IM application shutdown request, the logic can be modified to only display one close confirmation dialogue no matter how many sessions may have unread messages.

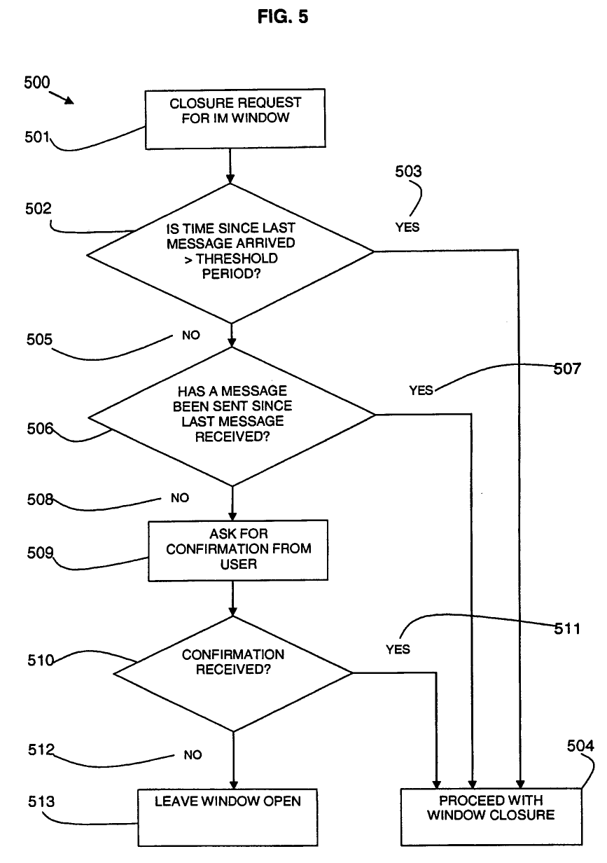

Referring to FIG. 5, a flow diagram 500 of the method of the second embodiment is shown. A closure request 501 is received for an IM window.

It is determined 502 if the time since the last message arrived is greater than a threshold time period. If so 503, the user will have had plenty of time to see the most recently received message and the window closure request proceeds 504.

If not 505, the time between the arrival of the last message and the closure request 501 may be too short for the user to have read the last message.

It is then determined 506, if a message has been sent by the user since the last message arrived. If so 507, the closure request may proceed 504 as the user must have seen the most recently received message before sending his message.

If not 508, confirmation 509 is requested from the user that the window should be closed. Such a confirmation request may be provided in the form of a dialogue box appearing on the screen with an associated sound which requires an answer before any further action may be taken.

It is determined 510, if confirmation has been received. If so 511, the window closure request may proceed 504. If not 512, the window will remain open 513.

Using these techniques prevents IM users from loosing messages as the result of windows being closed too early.

The invention is most applicable when messages are not persisted to disk at the IM client i.e. the messages will not be recovered at restart. However, it can still be used even if messages are persisted in order to ensure that a user gets to see a message before the client is closed.

The above description relates to instant messaging and the closure of instant messaging windows. The described methods also apply to other applications which involve a non-user generated notification or alert, in which it is important to prevent a user from overlooking the notification or alert when closing the application or a session of the application.

Another example embodiment would be an administration console that receives alerts of problems. The graphical user interface of the console must not be closed if an alert has not been seen. The described methods can be applied by testing whether the interface has been focused on since the last alert has been received or whether the time lapse since the last alert is greater than a threshold time period as described in detail in relation to the instant messaging application.

The present invention is typically implemented as a computer program product, comprising a set of program instructions for controlling a computer or similar device. These instructions can be supplied preloaded into a system or recorded on a storage medium such as a CD-ROM, or made available for downloading over a network such as the Internet or a mobile telephone network.

Improvements and modifications can be made to the foregoing without departing from the scope of the present invention.

1. A method for inhibiting overlooking notifications in an application comprising:
requesting closure of an application interface;
determining whether it is possible for a notification to have been overlooked;
in response to determining that this is possible, seeking confirmation of the closure.

2. The method of claim 1 wherein the determining step comprises:
checking if the application interface has been selected since the last notification; and
if the application interface has not been selected, seeking confirmation of the closure.

3. The method of claim 2, wherein the application interface is an application graphical window and wherein in the step of checking, if the application interface has been selected, carrying out the steps of:
checking if the application interface was selected for a time period less than a predefined threshold time period; and
if so, seeking confirmation of the closure.

4. The method of claim 3, wherein the application is an instant messaging client application, the application interface is an instant messaging session window, and the notification is a received message in an instant messaging session.

5. The method of claim 4, wherein after the step of requesting closure of an application interface, the method also includes:
checking if the time period since the last notification was received is less than a predefined threshold time period; and
if the time period is less than the threshold, seeking confirmation of the closure.

6. The method of claim 1, wherein the determining step comprises:
checking if the time period since the last notification was received is less than a predefined threshold time period; and
if the time period is less than the threshold, seeking confirmation of the closure.

7. The method of claim 6, wherein if an action has been carried out on the application after the last notification was received, skipping the step of seeking confirmation of the closure.

8. The method of claim 7, wherein the application is an instant messaging client application, the application interface is an instant messaging session window, and the notification is a received message in an instant messaging session.

9. The method of claim 8, wherein after the step of requesting closure of an application interface, the method also includes:
checking if the application interface has been selected since the last notification; and
if the application interface has not been selected, seeking confirmation of the closure.

10. A system for inhibiting overlooking notifications in an application comprising:
an application including means for receiving notifications;
an application interface for the application;
means for requesting closure of the application interface;
means for determining whether it is possible for a notification to have been overlooked;
means, responsive to determining that this is possible, for seeking confirmation of the closure.

11. The system of claim 10, wherein the determining means comprises:
means for checking, in response to a closure request, if the application interface has been selected since the last notification was received; and
the system further comprises means for seeking confirmation of the closure, if the application interface has not been selected,

12. The system of claim 10, wherein the application interface is an application graphical window and wherein the system further includes:
means for checking if the application interface was selected for a time period less than a predefined threshold time period; and
means, responsive to determining that the application was selected for a time period less than a predefined threshold time period, for seeking confirmation of closure.

13. The system of claim 12, wherein the system also includes:
means for checking if the time period since the last notification was received is less than a predefined threshold time period; and
means, responsive to the time period is less than a predetermined threshold time period, for seeking confirmation of closure.

14. The system of claim 10, wherein the determining step comprises:
means for checking, in response to a closure request, if the time period since the last notification was received is less than a predefined threshold time period; and
means for seeking confirmation of the closure, if the time period is less than the threshold.

15. The system of claim 14 comprising:
means for determining that an action has been carried out on the application after the last notification was received and consequently for not seeking confirmation of closure.

16. The system of claim 14, wherein the application is an instant messaging client application, the application interface is an instant messaging session window, and the notification is a received message in an instant messaging session.

17. The system of claim 14, wherein the system also includes:
means for checking if the application interface has been selected since the last notification; and
means, responsive to determining that the application interface has not been selected, for seeking confirmation of the closure.

18. A computer program product for inhibiting overlooking of notifications in an application, the computer program product stored on a computer readable storage medium, comprising computer readable program code means for performing the steps of:
requesting closure of an application interface;
determining whether it is possible for a notification to have been overlooked;
in response to determining that this is possible, seeking confirmation of the closure.

19. The computer program product of claim 18 comprising computer readable program code means for performing the steps of:
checking if the application interface has been selected since the last notification; and
if the application interface has not been selected, seeking confirmation of the closure.

20. The computer program product of claim 18 comprising program code means for performing the steps of:
checking if the time period since the last notification was received is less than a predefined threshold time period; and
if the time period is less than the threshold, seeking confirmation of the closure.
